(19) United States
(12) Patent Application Publication
(10) Pub. No.: US 2009/0251885 A1
(43) Pub. Date: Oct. 8, 2009

(54) Backlight Module

(75) Inventors: Chao-Shih Yen, Taitung City (TW); Chien-Tong Lee, Yingge Township (TW); Yao-Tsung Tsai, Banciao City (TW)

Correspondence Address: BACON & THOMAS, PLLC, 625 SLATERS LANE, FOURTH FLOOR, ALEXANDRIA, VA, 22314-1176, US

(73) Assignee: Forward Electronics Co., Ltd., Taipei City (TW)

(21) Appl. No.: 12/318,885

(22) Filed: Jan. 12, 2009

(30) Foreign Application Priority Data
Apr. 3, 2008 (TW) 097112357

(51) Int. Cl. G09F 13/08

(52) U.S. Cl. 362/97.1

(57) ABSTRACT

A backlight module includes a frame, a light bar, and a locating bar. The locating bar is connected between two sides of the frame. The light bar includes a circuit board and a plurality of lighting units, where the circuit board is secured on a support of the frame, and where the plural lighting units are engaged with plural locating grooves of the locating bar, such that the lighting units are confined by the locating grooves in a lateral direction. Therefore, during the steps in assembling the light bar, not only personnel are facilitated in the assembly work, but also the light bars can be sieved out during the assembly process, preventing the defect of material waste if illumination test is performed only after the whole backlight module has been finished.

### BACKGROUND OF THE INVENTION

1. Field of the Invention

The present invention relates to a backlight module, and more particularly, to an edge-lighting backlight module where an LED (light emitting diode) light bar can be assembled and orientated conveniently.

2. Description of Related Art

Conventionally, the measure in assembling an LED light bar includes securing the LED light bar on a light guide; or securing the LED light bar on the side of a plastic frame (as shown in FIG. 1). Referring to FIGS. 1 and 2, a perspective view illustrating a conventional backlight module and a cross-sectional view taken along cutting line A-A of FIG. 1, an LED light bar 3 includes a circuit board 4 and a plurality of LED lighting units 5 fixed on the circuit board 4. The LED light bar 3 is, with the circuit board 4, attached to the support 2 of a frame 1. The support 2 also provides a supporting function for other components, including, for example, a reflecting film (not shown).

FIG. 2 shows a complete assembly of the frame 1, the LED light bar 3, and other components including a light guide 6, a film 7, and a bracket 8. Also shown is that the conventional backlight can be designed, on the other hand, as that after the LED light bar 3 has been assembled to the frame 1, an illumination gap G1 will be maintained between the light guide 6 and illumination surfaces 9 of the LED lighting units 5 so as to facilitate uniformity of illumination in particular occasions.

Such a kind of known measure for assembling the LED light bar 3 in an LED backlight module may be summarized as follows: Personnel would first proceed, roughly, with an orientation manually between the LED light bar 3 and the support 2, and then secure the LED light bar 3 on the support 2. However, such an assembling measure is quite inaccurate in orientation. Or even if the LED light bar 3 achieves its orientation purpose, it cannot be assured that angle of illumination of the LED lighting units 5 is in an accurate direction. This is because during the process in bonding the plural LED lighting units 5 onto the circuit board 4, orientation of disposition may happen to be deviated. In spite of the fact that the angle of deviation may be minor, influence on the performance of products, however, is very significant.

It would be quite cost consuming if inspection is carried out on orientation of all the LED lighting units 5 disposed on the circuit board 4. Or if illumination test is performed only after the whole LED backlight module has been finished, it would be very material waste in case there is a defect on the orientation of the LED lighting units 5 for the reason that the whole LED backlight module is to be abandoned.

Further, in the conventional LED backlight module, even though an illumination gap G1 is maintained between the light guide 6 and the illumination surfaces 9 of the LED lighting units 5, distance of such a gap G1 cannot be always assured. This is because there is still a possibility for the light guide 6 to slide in the frame 1.

Accordingly, there is an urge for a design such that the LED light bar 3 can be accurately orientated on the frame 1 of the module, and that labor and cost for manufacture required can be lowered.

### SUMMARY OF THE INVENTION

According to the present invention, a backlight module includes a frame, a light bar, and a locating bar. The frame includes two sides and a support connected between the two sides. The light bar includes a circuit board and a plurality of lighting units, where the lighting units are secured on, and electrically connected with, the circuit board, and the circuit board is secured on the support.

The locating bar is connected between the two sides, and includes a front surface and a plurality of locating grooves provided on the front surface. The plural lighting units are, correspondingly and respectively, engaged with the plural locating grooves, such that the lighting units are confined by the locating grooves in a lateral direction.

With help of the above-mentioned structure, it is understood that during the steps in assembling the light bar, not only personnel are facilitated in the assembly work, but also the light bars having lighting units of defective orientation can, in the meantime, be sieved out during the assembly process. This will prevent the defect of material or time waste if illumination test is performed only after the whole backlight module has been finished.

An illumination surface of each of the plural lighting units and an opening of its corresponding locating groove are spaced apart from with a predetermined distance so as to assure uniformity of illumination. The locating grooves include at least one through groove, or at least one blind groove. The lighting unit located at the blind groove abuts upon a rear wall of the blind groove. This will provide the light bar, when in assembly, with an orientating function in a longitudinal direction. By means of this longitudinal orientation measure, a predetermined distance can be maintained between the lighting unit and the opening of the locating groove.

The frame is a rectangular frame, with the two sides of the frame parallel with and opposed to each other. The lighting units may be plural LED lighting units. The locating bar and the frame may be made integrally in one piece.

Other objects, advantages, and novel features of the present invention will become more apparent from the following detailed description when taken in conjunction with the accompanying drawings.

### BRIEF DESCRIPTION OF THE DRAWINGS

FIG. 1 is a perspective view illustrating a conventional backlight module;

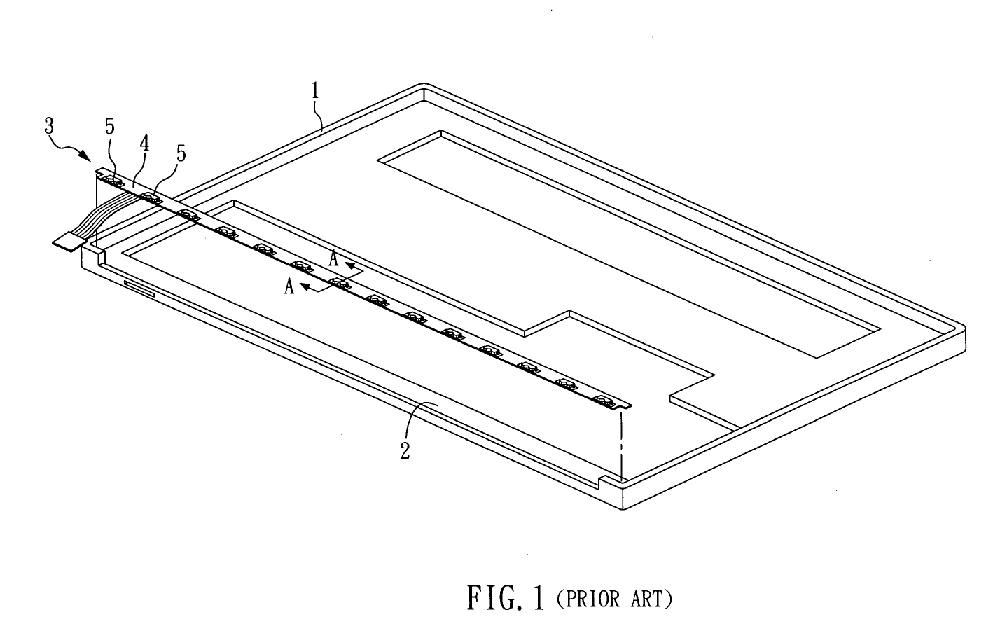

FIG. 2 is a cross-sectional view taken along cutting line A-A of FIG. 1;

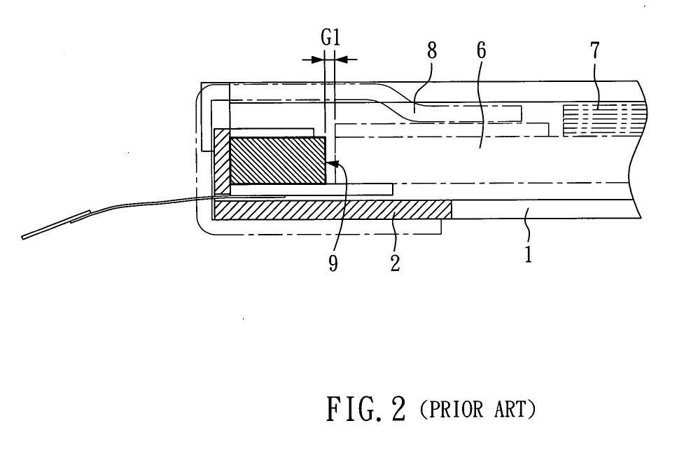

FIG. 3 is a perspective view illustrating a backlight module according to the present invention;

FIG. 4 is a perspective view illustrating part of the backlight module according to the present invention in a different view angle; and

FIG. 5 is a cross-sectional view taken along cutting line B-B of FIG. 3.

### DETAILED DESCRIPTION OF THE PREFERRED EMBODIMENTS

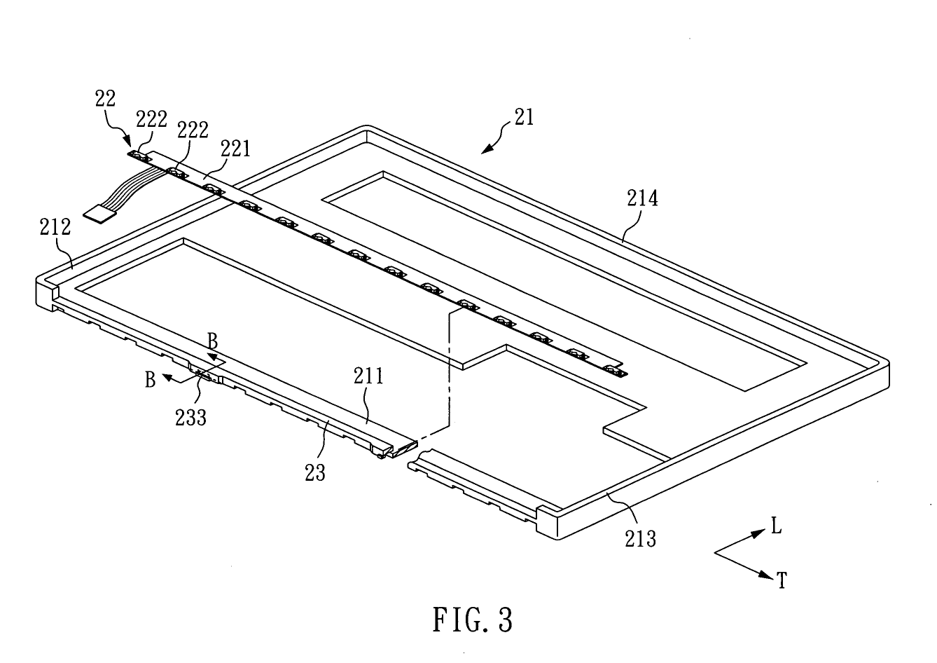

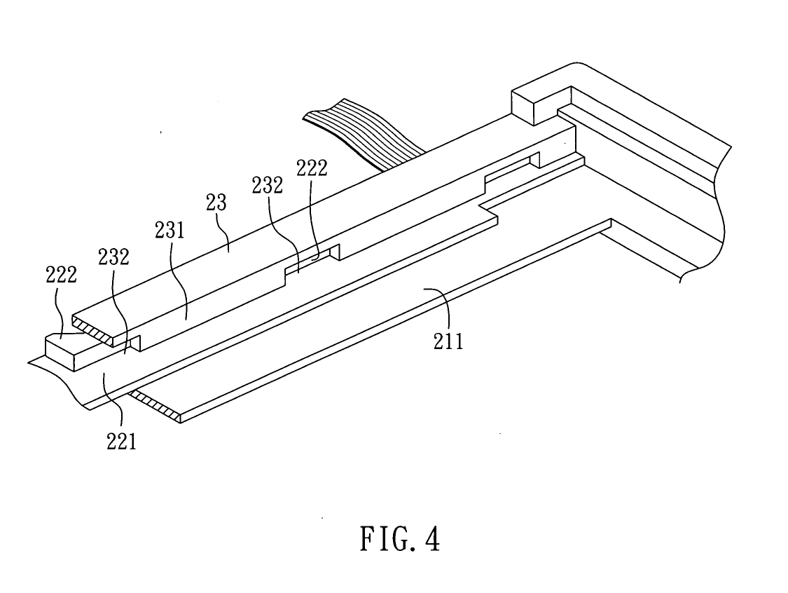

Referring to FIGS. 3 and 4, perspective views illustrating a backlight module according to the present invention in different view angles, an edge-lighting LED backlight module includes a frame 21 and a light bar. The frame 21 includes two sides 212,213 parallel with and opposed to each other, a support 211 connected between the two sides 212,213, and a connecting segment 214 parallel with and opposed to the support 211 and likewise connected with the two sides 212,213. The four parts, as mentioned above, constitute together the frame 21 having a rectangular contour.

In the frame 21 and at the same side as the support 211, there is also provided with a locating bar 23 which is likewise connected between the two sides 212,213. The support 211, the two sides 212,213, the connecting segment 214, and the locating bar 23 are made integrally in one piece.

The light bar refers to an LED light bar 22 including a circuit board 221 and a plurality of LED lighting units 222, where the LED lighting units 222 are, in a certain spacing, wire-bonded on, and electrically connected with, the circuit board 221. In the present invention, the circuit board 221 refers to a flexible circuit board; while of course, a solid circuit board will also do.

The locating bar 23 includes a front surface 231 facing inside of the rectangular frame 21. A plurality of locating grooves 232 are provided on the front surface 231, wherein some of the locating grooves 232 relate to blind grooves each having a rear wall 233. In the present invention, there is one blind groove, and the rest of the locating grooves 232 are through grooves.

When the LED light bar 22 is assembled on the frame 21, the only thing to do is to align and engage the LED lighting units 222 with the locating grooves 232, and to stick the circuit board 221 to the support 211. Such a structure facilitates the work of assembly and alignment.

Since the locating groove 232 acts as a receiving chamber for the LED lighting unit 222, the width of the locating groove 232, in design, should base on the width of the LED lighting unit 222. When the LED lighting units 222 are engaged with the locating grooves 232, the LED lighting units 222 are confined by the locating grooves 232 in a lateral direction T. Relying on current technology which has achieved precision in a micron level, it is likely to make the locating grooves 232 which receive the LED lighting units 222 within an acceptable tolerance against deviation of disposition. Such a structure facilitates not only assembling and orientating the LED light bar 22, but also determining and selecting qualified the LED light bars 22. That is to say, when the LED light bars 22 cannot be engaged with the locating bar 23 without difficulty, the LED light bars 22 would be considered defective.

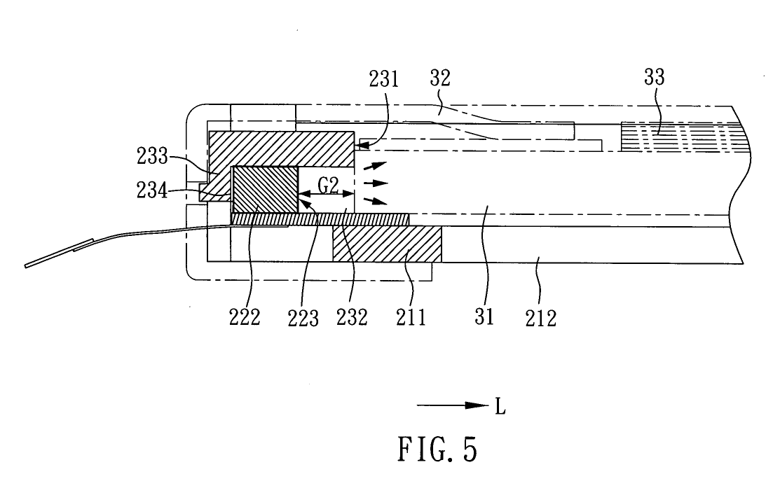

Now referring to FIG. 5, a cross-sectional view of the backlight module according to the present invention, there are shown other components of the backlight module including a bracket 32, a film 33, and a light guide 31. Due to the provision of the blind groove, the LED lighting units 222 of the LED light bar 22 can move into and be engaged with the locating grooves 232 of the locating bar 23. In other words, the LED lighting units 222, after being engaged with the locating grooves 232, will reach to a surface 234 of the rear wall 233, as an “end of movement.” This will provide the LED light bar 22, when in assembly, with an orientating function in a longitudinal direction L.

As shown in FIG. 5, when the LED lighting unit 222 abuts upon the rear wall 233 of the blind groove, an illumination surface 223 of the LED lighting unit 222 and an opening of the locating groove 232 (in the same plane as the front surface 231) will be spaced apart from with an illumination gap G2 (the direction of the arrows indicates the direction of light emission of the LED lighting unit 222). Therefore, so long as the locating bar 23 is so designed as that when the LED lighting unit 222 reaches the “end of movement,” the illumination gap G2 is maintained between the illumination surface 223 and the front surface 231, the illumination gap G2 can be assured between the light guide 31 and the LED lighting unit 222, after the light guide 31 is assembled into the frame 21 subsequently, without the defect of possible sliding for the light guide as for the conventional art. In the present invention, the illumination gap G2 is about 0.2 mm.

In view of the above, it is understood that light emission direction test for the lighting units can be proceeded without the need to wait until finishing the assembly of the backlight module. In other words, during the steps in assembling the light bar, the locating bar can provide the light bar an accurate orientation and assure accurate disposition of the lighting units on the circuit board, without adding to personnel any extra complexity in the process of assembly. Besides, the light bars having lighting units of defective orientation can, in the meantime, be sieved out during the assembly process.

Further, as far as the light guide in the backlight module is concerned, the problem of non-uniform illumination, due to nearness between the light guide and the lighting units, can be solved by the blind groove accompanied with the illumination gap. In the conventional backlight module, however, solution to such a problem is absent. Therefore, the backlight module, according to the present invention, is indeed an innovative structure.

In particular, the present invention provides a low cost and efficiency-promoting solution in the trend that increasing LED lighting units are utilized in backlight modules.

Although the present invention has been explained in relation to its preferred embodiments, it is to be understood that many other possible modifications and variations can be made without departing from the scope of the invention as hereinafter claimed.

What is claimed is:

1. A backlight module, comprising:
a frame, including two sides and a support connected between the two sides; and
a light bar, including a circuit board and a plurality of lighting units, wherein the lighting units are secured on, and electrically connected with, the circuit board, and the circuit board is secured on the support;
characterized in that:
the backlight module further comprises a locating bar connected between the two sides and including a front surface and a plurality of locating grooves provided on the front surface, where the plural lighting units are, correspondingly and respectively, engaged with the plural locating grooves, such that the lighting units are confined by the locating grooves in a lateral direction.

2. The backlight module as claimed in claim 1, wherein the plural locating grooves include at least one through groove.

3. The backlight module as claimed in claim 1, wherein an illumination surface of each of the plural lighting units and an opening of its corresponding locating groove are spaced apart from with a predetermined distance.

4. The backlight module as claimed in claim 1, wherein the locating grooves include at least one blind groove, and the lighting unit located at the blind groove abuts upon a rear wall of the blind groove.

5. The backlight module as claimed in claim 4, wherein an illumination surface of each of the plural lighting units and an opening of its corresponding locating groove are spaced apart from with a predetermined distance.

6. The backlight module as claimed in claim 1, wherein the frame is a rectangular frame.

7. The backlight module as claimed in claim 1, wherein the two sides of the frame are parallel with and opposed to each other.

8. The backlight module as claimed in claim 1, wherein the lighting units are plural LED lighting units.

9. The backlight module as claimed in claim 1, wherein the locating bar and the frame are made integrally in one piece.
